(19) United States
(12) Patent Application Publication
(10) Pub. No.: US 2017/0178139 A1
(43) Pub. Date: Jun. 22, 2017

(54) Analysis of Transaction Information Using Graphs

(71) Applicant: ACI Worldwide Corp., Elkhorn, NE (US)

(72) Inventor: Eric James Gieseke, Lincoln, MA (US)

(73) Assignee: ACI Worldwide Corp., Elkhorn, NE (US)

(21) Appl. No.: 14/974,786

(22) Filed: Dec. 18, 2015

(51) Int. Cl. G06Q 20/40; G06T 11/20

(52) U.S. Cl. CPC G06Q 20/4016; G06T 11/206

(57) ABSTRACT

A system comprises a memory that includes instructions, an interface, and one or more processors communicatively coupled to the memory and interface. The interface is configured to receive transaction information for a plurality of transactions. The processor is configured to generate a graph database based on the transaction information, and determine, based on information associated with the nodes of the graph database, whether a particular node of the graph database is potentially fraudulent.

### TECHNICAL FIELD

The present disclosure relates generally to analyzing transactions for fraudulent activity, and more specifically to generating a graph of transaction information and determining whether transactions are potentially fraudulent or nodes are compromised based on relationships in the graph.

### BACKGROUND

Transactions may sometimes be carried out by users other than an account owner, such as by a user that has gained unauthorized access to an account owner's information (e.g., credit card information). Accordingly, details associated with an account's transactions may be analyzed to determine whether particular transactions were likely performed by the account owner or by another unauthorized person.

### BRIEF DESCRIPTION OF THE DRAWINGS

For a more complete understanding of particular embodiments and their advantages, reference is now made to the following description, taken in conjunction with the accompanying drawings, in which:

FIG. 1 illustrates an example graph of transaction information in accordance with embodiments of the present disclosure;

FIGS. 2A-2F illustrate example data structures associated with transaction information for use in a graph database in accordance with embodiments of the present disclosure;

FIG. 3 illustrates an example method for determining whether transactions are potentially fraudulent or nodes are compromised using graphs of transaction information in accordance with embodiments of the present disclosure; and

FIG. 4 illustrates an example computer system in accordance with embodiments of the present disclosure.

### DETAILED DESCRIPTION OF EXAMPLE EMBODIMENTS Overview

A system comprises a memory that includes instructions, an interface, and one or more processors communicatively coupled to the memory and interface. The interface is configured to receive transaction information for a plurality of transactions. The processor is configured to generate a graph database based on the transaction information, and determine, based on information associated with the nodes of the graph database, whether a particular node of the graph database is potentially fraudulent.

Embodiments of the present disclosure may provide numerous technical advantages. For example, certain embodiments of the present disclosure may allow for enhanced fraud detection capabilities using graph databases. As another example, certain embodiments may allow for horizontal scaling of graph database technologies. Other technical advantages of the present disclosure will be readily apparent to one skilled in the art from the following figures, descriptions, and claims. Moreover, while specific advantages have been enumerated above, various embodiments may include all, some, or none of the enumerated advantages.

### DETAILED DESCRIPTION

The present disclosure describes systems and methods for determining whether transactions are potentially fraudulent using graphs of transaction information. In particular, the present disclosure applies graph concepts to model and analyze multiple financial transactions for potential fraud risk using a multi-dimensional analysis, and may use distributed graph database technologies to support analysis of large volumes of transaction information. Using the generated graph of transaction information for a number of transactions, it may be determined that many transactions associated with a particular user and/or user account are fraudulent. In addition, using the graph, it may be determined whether particular terminals are compromised. Transaction information may include one or more details of a payment or other type of financial transaction. In particular embodiments, transaction information may include event information and dimension information. Event information may include one or more details about the transaction, such as the transaction date/time, transaction amount, and/or transaction type. Dimension information may include information about involved parties and other aspects of the transaction, such as terminal information, terminal location information, information associated with a user involved in the transaction, and/or information associated with the account(s) involved in the transaction (including one or more financial institutions involved).

Using the event information and dimension information, a graph may be generated that indicates the various relationships between the event information and dimension information. After generating the graph of transaction information, the relationships between the event information and dimension information may be analyzed in order to determine whether particular dimensions may be potentially fraudulent or compromised. For example, in certain embodiments, a risk score may be determined for each node in the graph, which may take into account the average risk score for each neighbor node. Based on the analysis, one or more flags or other indications (e.g., risk scores or probabilities) may be made with respect to the nodes to indicate its status. For example, if the determined risk score is above a particular threshold, then the node may be flagged (e.g., using an attribute in the data structure) as potentially fraudulent or compromised. In graphical representations of the graph, the fraudulent or compromised status of a node may be visually indicated based on the flag. For example, a known fraudulent or compromised node may be color-coded red and potentially fraudulent or compromised nodes may be color-coded yellow.

In certain embodiments, multiple other types or sources of data may be integrated in the graph in addition to transaction information, including demographic events containing non-transaction sources of data or social network or social graph information. For example, user nodes not associated through transaction information but associated with one another in a social network may be associated with one another in the graph. As another example, information from “white hat” organizations identifying known compromised accounts may be integrated in the graph. By compiling information from many sources, the compiled graph may be used to analyze transaction information for fraudulent activity with greater accuracy.

By applying graph concepts to transaction information according to the present disclosure, fraudulent activity may be more easily and accurately detected, increasing fraud detection performance and costs associated therewith. In addition, aspects of the present disclosure may allow for faster analysis of large scale transaction information, further allowing distributed graph database technologies to scale horizontally. This may be accomplished by faster pattern analysis, i.e., through the detection of patterns in nodes that indicate fraudulent or compromised activity. As an example, by determining that many account nodes associated with a particular terminal are flagged as potentially fraudulent, it may be determined that the terminal has been compromised. As another example, a “bust out” pattern of fraudulent activity caused by a single unauthorized user of many accounts (e.g., a single user opens many fraudulent accounts that do not initially appear to be fraudulent by typical measures, but then “busts out” with large spending on each account) may be more quickly recognized by determining that each account links to the same user node, IP address, or other type of node.

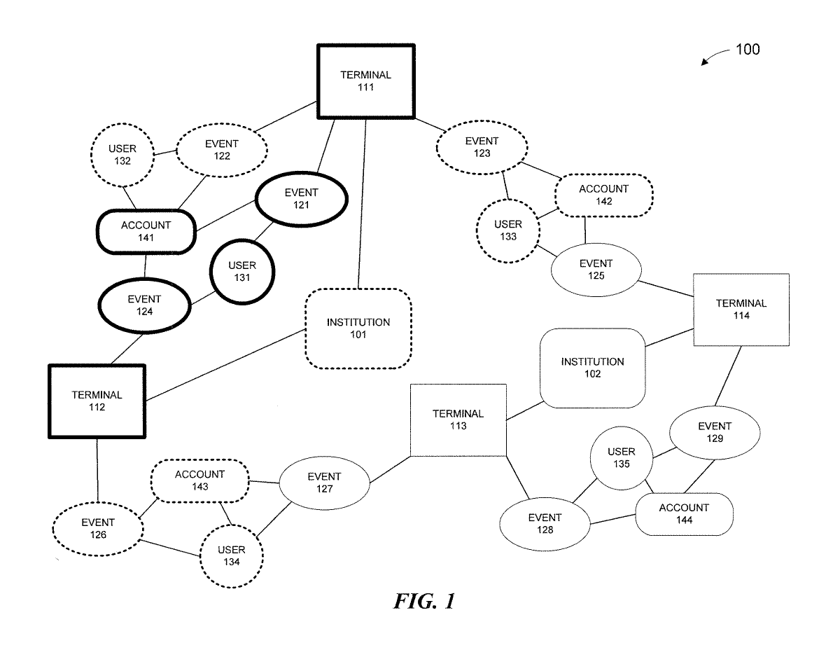

To facilitate a better understanding of the present disclosure, the following examples of certain embodiments are given. In no way should the following examples be read to limit, or define, the scope of the disclosure. Embodiments of the present disclosure and its advantages may be best understood by referring to FIGS. 1-4, where like numbers are used to indicate like and corresponding parts

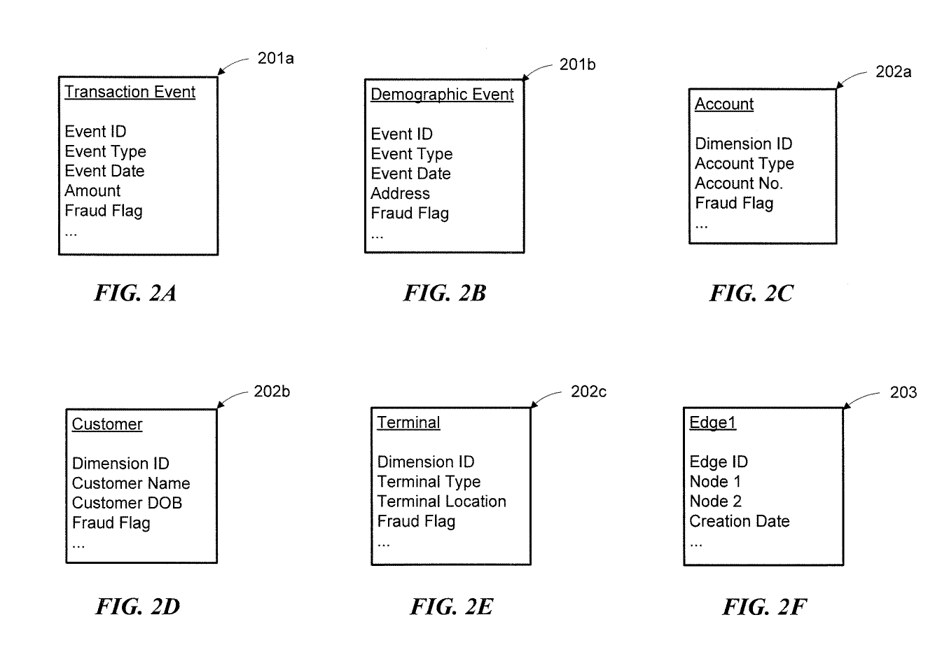

FIG. 1 illustrates an example graph 100 of transaction information in accordance with embodiments of the present disclosure. Graph 100 comprises a plurality of nodes connected by edges. Nodes may refer to certain elements of the transaction information, while edges may refer to information that associates such elements with one another. Nodes and/or edges may comprise one or more properties associated therewith, and may be representations of certain data structures (e.g., the data structures of FIGS. 2A-2F) in particular embodiments. The nodes of graph 100 may include or be associated with any suitable transaction information. For instance, graph 100 comprises nodes representing institutions 101-102 (e.g., banks), transaction terminals 111-114 (e.g., point-of-sale (POS) terminals, automatic teller machines (ATMs), online merchant servers, etc.), events 121-129 representing unique transactions occurring at terminals (e.g., credit or debit card transactions), users 131-135 associated with the events 121-129, and accounts 141-144 associated with the events 121-129. Edges may comprise any suitable relationship information for associating the various nodes with one another, such as information about the relationship or when it was created (e.g., a transaction date).

Graph 100 may provide an efficient and flexible mechanism for storing and visualizing transaction information. This is because a graph database may support a dynamic schema where attributes may be added on an ad hoc basis, which, as compared with traditional relational databases, does not require a pre-defined schema. Accordingly, sparsely populated entries may not affect the efficiency of the graph database as it would with a traditional relational database.

To generate graph 100, transaction information may be received and processed to generate the nodes of graph 100 in any suitable manner. For example, transaction information may be parsed to separate its constituent elements into event information and dimension information. The event information may include one or more details about the transaction, such as the transaction date, transaction amount, and/or transaction type. The dimension information may include information about involved parties and other aspects of the transaction, such as terminal information, location information, date/time information, information associated with the user performing the transaction, and/or information associated with the account(s) involved in the transaction (e.g., financial institution(s)). The event information and dimension information may then be placed into the graph database, and associated with one another using edges that indicate relationship information.

Once placed into the graph database, nodes of graph 100 may be visually indicated based on particular properties or attributes, such as information associated with fraudulent activity. The visual indications may take any suitable form. For example, as illustrated, certain nodes may be bolded if they are associated with known fraudulent transactions or known to have been compromised, or may be outlined with dotted lines rather than solid lines if they are determined to be potentially fraudulent or compromised. As another example, certain nodes may be color-coded red if they are associated with known fraudulent transactions or known to have been compromised, or may be color-coded yellow if they are determined to be potentially fraudulent or compromised.

First, fraud status information may be updated for nodes known to be associated with fraudulent activity. For instance, referring to graph 100, terminal 111 and terminal 112 may be determined to be associated with known fraudulent transactions (i.e., events 121 and 124) performed by user 131 using account 141 (e.g., an unauthorized user using a stolen credit card at two different locations). This determination may be made using any suitable fraud analysis techniques, such as those described herein or known fraud analysis techniques. As an example, a user associated with account 141 may have indicated such transactions as fraudulent and/or unauthorized. Once the determination is made that a particular node is known to be fraudulent or compromised, fraud status information associated with the particular node may be updated. This may be done, for instance, using an attribute (e.g., flag attribute) in a data structure associated with the node.

The known fraud status information of nodes may then be used to determine whether other nodes of graph 100 may be fraudulent, and the fraud status information of such nodes may be updated accordingly. This determination may be done in any suitable manner. For example, a risk score may be determined for each node. The risk score may be based on the average risk score of each other node associated therewith. In addition, a potential loss value may be determined for each node that includes a mathematical determination (e.g., a sum) of transaction amounts associated with the particular node. If the risk score is above a certain threshold, then the fraud status information may indicate that the node is potentially fraudulent. A flag or other type of risk attribute in the data structure may be updated accordingly, and/or the node may be visually indicated in the graph accordingly. In addition, an alert may be generated to prompt a fraud analyst to review such event or dimension information further. Referring to graph 100, because nodes 111, 121, 131, 141, 124, and 112 of graph 100 are known to be associated with fraudulent activity, other nodes in graph 100 that are closely related to those may be flagged and/or visually indicated in the graph 100 as potentially fraudulent. Thus, institution 101, events 122, 123, and 126 may be flagged as potentially fraudulent, along with the users 132-134 and/or accounts 142-143 associated therewith. However, other nodes in graph 100 may be otherwise unchanged (and visually indicated accordingly).

Modifications, additions, or omissions may be made to FIG. 1 without departing from the scope of the present disclosure. For example, nodes or edges of graph 100 are illustrated in a particular manner. However, the nodes and/or edges may be visually indicated in any suitable manner, including visualizing one or more attributes of the nodes in graph 100. As another example, graph 100 may include fewer or additional nodes or edges than illustrated. As yet another example, nodes of graph 100 may include geographical information, and graph 100 may be overlaid onto a map according to the geographical information in the nodes of graph 100. As yet another example, real-time visualization of graph 100 may be provided, wherein transaction information is updated in the graph as it is acquired. Such real-time visualization of graph 100 may allow for more time-based analyses to occur (e.g., seeing “bust out” patterns occur within smaller time windows).

FIGS. 2A-2F illustrate example data structures 201-203 associated with transaction information for use in a graph database in accordance with embodiments of the present disclosure. In particular, data structures 201 are examples of event information, data structures 202 are examples of dimension information, and data structures 203 is an example of edge information that associates two or more of event or dimension information with one another. Data structure 201a illustrates event information associated with a transaction event (e.g., a financial transaction), and data structure 201b illustrates event information associated with a demographic event (e.g., an addition of information of a node or change in information of a node). Data structure 202a illustrates dimension information associated with an account (e.g., checking account, credit card account, or the like), data structure 202b illustrates dimension information associated with a customer (e.g., information associated with an account owner or an authorized user), and data structure 202c illustrates dimension information associated with a terminal (e.g., POS terminal or ATM).

Data structures 201 and 202 each include properties associated with the respective events or dimensions they represent. For example, each of data structures 201 that represent event information includes properties that uniquely identify the data structure or node (i.e., “Event ID”), that describe the type of event (i.e., “Event Type”), note the date of the event (i.e., “Event Date”), and that indicate fraud status information (i.e., “Fraud Flag”). Data structure 201a further includes a property that indicates an amount of the transaction that the event information represents (i.e., “Amount”), while data structure 201b further includes a property that indicates demographic information changed in the demographic event (i.e., “Address”). Furthermore, each of data structures 202 that represent dimension information includes properties that uniquely identify the data structure or node (i.e., “Dimension ID”) and that indicate fraud status information (i.e., “Fraud Flag”). Data structure 202a further includes properties that indicate a type of account (i.e., “Account Type”) and an account number (i.e., “Account No.”). Data structure 202b further includes properties that indicate a customer name (i.e., “Customer Name”) and date of birth (i.e., “Customer DOB”). Data structure 202c further includes properties that indicate a terminal type (i.e., “Terminal Type”) and a terminal location (i.e., “Terminal Location”).

Data structures 201 and/or 202 maybe associated with one another in a graph database using one or more edges in certain embodiments. Data structure 203 illustrates an example data structure that represents edge information, which may be similar to data structures 201 and 202. For example, edge data structures may include properties that uniquely identify the edge (i.e., “Edge ID”) and identify two or more data structures that are associated with one another (i.e., “Node 1” and “Node 2”). Additionally, edges may include properties that identify other attributes relating to the association, such as a date that the association was created (i.e., “Creation Date”).

Modifications, additions, or omissions may be made to data structures 201-203 of FIGS. 2A-2F without departing from the scope of the present disclosure. For example, any of data structures 201-203 may have additional or fewer properties than those illustrated. As another example, certain data structures may be combined with one another to create complex data structures in particular embodiments. For instance, customer and merchant information may be combined into a single data structure, which may assist in analyzing transaction patterns between the customers and merchants (e.g., recognizing when a customer makes a purchase that is much larger than normal at a particular merchant). These complex data structures may be illustrated in the graph, and may be toggled on or off in certain embodiments (i.e., switched between the singular data structures and the complex data structures).

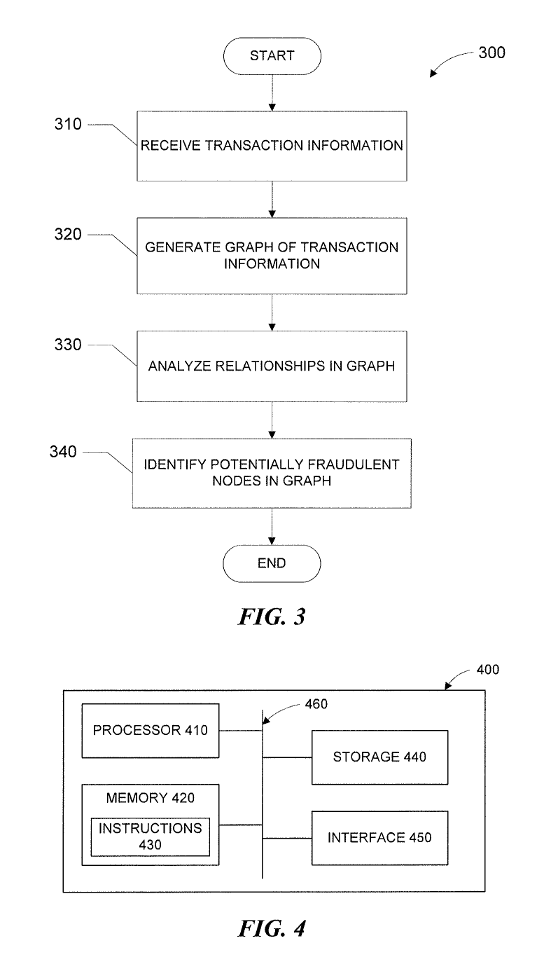

FIG. 3 illustrates an example method 300 for determining whether transactions are potentially fraudulent or nodes are compromised using graphs of transaction information in accordance with embodiments of the present disclosure. Method 300 may be performed using one or more computer systems, such as computer system 400 of FIG. 4 (described further below). For instance, method 300 may be performed by a processor executing instructions embodied in a computer readable medium.

Method 300 may begin at step 310, where transaction information is received for a plurality of transactions. The transaction information may include any suitable information associated with a transaction. In particular embodiments, the transaction information may include event information and dimension information. The event information may include transaction events (i.e., information that describes a financial transaction) or demographic events (i.e., information that describes changes in node information, such as changes in physical addresses, electronic mail addresses, or social network information). Event information may include, in certain embodiments, information related to a transaction date/time, a transaction amount, or a transaction type. Dimension information may include, in certain embodiments, information related to terminal information, terminal location information, information associated with a user involved in a transaction, or information associated with an account involved in the transaction.

At step 320, a graph is generated that represents the transaction information. This may include generating and/or populating elements of a graph database, in particular embodiments. To populate the graph database elements, the transaction information may be parsed. For example, the transaction information may be parsed into its constituent event information and dimension information, and data structures that represent each respective type of information may be generated. These data structures maybe similar to data structures 201 and 202, respectively, of FIGS. 2A-2E. That is, the data structures generated to represent the event information may be similar to data structures 201 of FIGS. 2A-2B, while the data structures generated to represent the dimension information may be similar to data structures 202 of FIGS. 2C-2E. The various data structures may be associated with one or more other data structures using edges to form the graph. The edges may also be represented by data structures, and may be similar to data structure 203 of FIG. 2F.

At step 330, relationships between the nodes of the graph are analyzed. This may include determining a risk score for each particular node in the graph. The risk score for each particular node may be based on the average risk score of each other node associated therewith. The risk score may also be based on the average risk score of nodes within a particular degree of association (e.g., nodes separated from the particular node by a certain number of other nodes). This step may also include, in certain embodiments, determining a potential loss value. The potential loss value may be based on a mathematical determination (e.g., a sum) of transaction amounts associated with the particular node.

Finally, at step 340, potentially fraudulent nodes in the graph are identified based on the analysis performed in step 330. For example, if the risk score is above a certain threshold, then fraud status information associated with a node may be modified to indicate that the node is potentially fraudulent. A flag attribute in the data structure may be updated accordingly, in particular embodiments. In certain embodiments, the node may be visually indicated in the graph, such as by color-coding. Furthermore, an alert may be generated to prompt further review of the potentially fraudulent event or dimension information. The alert may be generated within the graph (e.g., by flashing the visualized node) or outside of the graph (e.g., by sending an electronic mail message, a text message, or the like). The alert may be an alert with respect to a particular node or event, or may be with respect to a “case” (i.e., a collection of nodes or events).

In particular embodiments, positive and negative profiling of nodes may be used. Positive profiling may refer to determining whether it was the particular user associated with an account performing a transaction, while negative profiling may refer to determining whether it was an unauthorized user of an account performing the transaction. Triangulation may be used to positively identify the user in certain embodiments. A positive profile may be constructed based on location information associated with a node, retailer/customer information, a time of day, an IP address, or any suitable type of information that may help to validate that the user associated with an account is where the transaction associated with the account is being conducted. If it is possible to positively identify the person conducting the transaction using positive and/or negative profiling, then the likelihood of the transaction being fraudulent becomes extremely low. The converse is also true; i.e., if it can be determined that it is not the actual card holder conducting the transaction, then it is highly likely that the transaction is fraudulent. By using a graph of transaction information, positive and/or negative profiling may be more accurately performed,

A technique of triangulation can be used to positively identify the user. A positive profile can be constructed based on the location, retailer, time of day, IP address, or other sources of data that help to validate that the user is where the transaction is being conducted.

Modifications, additions, or omissions may be made to method 300 without departing from the scope of the present disclosure. For example, the order of the steps may be performed in a different manner than that described and some steps may be performed at the same time. Additionally, each individual step may include additional steps without departing from the scope of the present disclosure.

FIG. 4 illustrates an example computer system 400, in accordance with embodiments of the present disclosure. One or more aspects of computer system 400 may be used in accordance with the present disclosure. Computer system 400 may include a processor 410, memory 420 comprising instructions 430, storage 440, interface 450, and bus 460. These components may work together to perform one or more steps of one or more methods (e.g. method 300 of FIG. 3) and provide the functionality described herein. For example, in particular embodiments, instructions 430 in memory 420 may be executed on processor 410 in order to analyze relationships in a graph database to determine whether nodes in the database are potentially fraudulent. In certain embodiments, instructions 430 may reside in storage 440 instead of, or in addition to, memory 420.

Processor 410 may be a microprocessor, controller, application specific integrated circuit (ASIC), or any other suitable device or logic operable to provide, either alone or in conjunction with other components (e.g., memory 420 and instructions 430) functionality according to the present disclosure. In particular embodiments, processor 410 may include hardware for executing instructions 430, such as those making up a computer program or application. As an example and not by way of limitation, to execute instructions 430, processor 410 may retrieve (or fetch) instructions 430 from an internal register, an internal cache, memory 420, or storage 440; decode and execute them; and then write one or more results of the execution to an internal register, an internal cache, memory 420, or storage 440.

Memory 420 may be any form of volatile or non-volatile memory including, without limitation, magnetic media, optical media, random access memory (RAM), read-only memory (ROM), flash memory, removable media, or any other suitable local or remote memory component or components. Memory 420 may store any suitable data or information utilized by computer system 400, including software (e.g., instructions 430) embedded in a computer readable medium, and/or encoded logic incorporated in hardware or otherwise stored (e.g., firmware). In particular embodiments, memory 420 may include main memory for storing instructions 430 for processor 410 to execute or data for processor 410 to operate on. In particular embodiments, one or more memory management units (MMUs) may reside between processor 410 and memory 420 and facilitate accesses to memory 420 requested by processor 410.

Storage 440 may include mass storage for data or instructions (e.g., instructions 430). As an example and not by way of limitation, storage 440 may include a hard disk drive (HDD), a floppy disk drive, flash memory, an optical disc, a magneto-optical disc, magnetic tape, a Universal Serial Bus (USB) drive, a combination of two or more of these, or any suitable computer readable medium. Storage 440 may include removable or non-removable (or fixed) media, where appropriate. Storage 440 may be internal or external to computer 400, where appropriate. In some embodiments, instructions 430 may be encoded in storage 440 in addition to, in lieu of, memory 420.

Interface 450 may include hardware, encoded software, or both providing one or more interfaces for communication (such as, for example, packet-based communication) between computer systems on network 110 (e.g., between terminals). As an example, and not by way of limitation, interface 450 may include a network interface controller (NIC) or network adapter for communicating with an Ethernet or other wire-based network and/or a wireless NIC (WNIC) or wireless adapter for communicating with a wireless network. Interface 450 may include one or more connectors for communicating traffic (e.g., IP packets) via a bridge card. Depending on the embodiment, interface 450 may be any type of interface suitable for any type of network in which computer system 400 is deployed. In some embodiments, interface 450 may include one or more interfaces for one or more I/O devices. One or more of these I/O devices may enable communication between a person and computer system 400. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these.

Bus 460 may include any combination of hardware, software embedded in a computer readable medium, and/or encoded logic incorporated in hardware or otherwise stored (e.g., firmware) to communicably couple components of computer system 400 to each other. As an example and not by way of limitation, bus 460 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 460 may include any number, type, and/or configuration of buses 460, where appropriate. In particular embodiments, one or more buses 460 (which may each include an address bus and a data bus) may couple processor 410 to memory 420. Bus 460 may include one or more memory buses.

Modifications, additions, or omissions may be made to FIG. 4 without departing from the scope of the present disclosure. For example, FIG. 4 illustrates components of computer system 400 in a particular configuration. However, any configuration of processor 410, memory 420, instructions 430, storage 440, interface 450, and bus 460 may be used, including the use of multiple processors 410 and/or buses 460. In addition, computer system 400 may be physical or virtual.

Although the present disclosure includes several embodiments, changes, substitutions, variations, alterations, transformations, and modifications may be suggested to one skilled in the art, and it is intended that the present disclosure encompass such changes, substitutions, variations, alterations, transformations, and modifications as fall within the spirit and scope of the appended claims.

What is claimed is:

1. A system, comprising:
a memory comprising instructions;
an interface configured to:
receive transaction information for a plurality of transactions; and
one or more processors communicatively coupled to the interface and the memory, the one or more processors configured, when executing the instructions, to:
generate, based on the transaction information, a graph database comprising a plurality of nodes connected by edges, each node representing at least a portion of the transaction information for a transaction of the plurality of transactions; and
determine, based on information associated with the nodes of the graph database, whether a particular node of the graph database is potentially fraudulent.

2. The system of claim 1, wherein determining whether a particular node of the graph database is potentially fraudulent comprises determining a risk score associated with the particular node.

3. The system of claim 2, wherein determining whether a particular node of the graph database is potentially fraudulent further comprises comparing the risk score to a threshold.

4. The system of claim 1, wherein the transaction information comprises event information and dimension information.

5. The system of claim 4, wherein:
one or more nodes of the graph database represent the event information;
one or more nodes of the graph database represent the dimension information; and
the edges indicate association information for the nodes.

6. The system of claim 1, wherein the one or more processors are further configured, when executing the instructions, to determine, for the particular node, a potential loss value.

7. The system of claim 1, wherein the one or more processors are further configured, when executing the instructions, to provide a visualization of at least a portion of the graph database.

8. A method, comprising:
receiving transaction information for a plurality of transactions;
generating, based on the transaction information, a graph database comprising a plurality of nodes connected by edges, each node representing at least a portion of the transaction information for a transaction of the plurality of transactions; and
determining, based on information associated with the nodes of the graph database, whether a particular node of the graph database is potentially fraudulent.

9. The method of claim 8, wherein determining whether a particular node of the graph database is potentially fraudulent comprises determining a risk score associated with the particular node.

10. The method of claim 9, wherein determining whether a particular node of the graph database is potentially fraudulent further comprises comparing the risk score to a threshold.

11. The method of claim 8, wherein the transaction information comprises event information and dimension information.

12. The method of claim 11, wherein:
one or more nodes of the graph database represent the event information;
one or more nodes of the graph database represent the dimension information; and
the edges indicate association information for the nodes.

13. The method of claim 8, further comprising determining, for the particular node, a potential loss value.

14. The method of claim 8, further comprising providing a visualization of at least a portion of the graph database.

15. A computer readable medium comprising instructions configured, when executed by a processor, to:
receive transaction information for a plurality of transactions;
generate, based on the transaction information, a graph database comprising a plurality of nodes connected by edges, each node representing at least a portion of the transaction information for a transaction of the plurality of transactions; and
determine, based on information associated with the nodes of the graph database, whether a particular node of the graph database is potentially fraudulent.

16. The computer readable medium of claim 15, wherein determining whether a particular node of the graph database is potentially fraudulent comprises determining a risk score associated with the particular node.

17. The computer readable medium of claim 16, wherein determining whether a particular node of the graph database is potentially fraudulent further comprises comparing the risk score to a threshold.

18. The computer readable medium of claim 15, wherein the transaction information comprises event information and dimension information.

19. The computer readable medium of claim 18, wherein:
one or more nodes of the graph database represent the event information;
one or more nodes of the graph database represent the dimension information; and
the edges indicate association information for the nodes.

20. The computer readable medium of claim 15, wherein the instructions configured, when executed by the processor, to determine, for the particular node, a potential loss value.
